(19) United States
(12) Patent Application Publication
(10) Pub. No.: US 2005/0238940 A1
(43) Pub. Date: Oct. 27, 2005

(54) Stack for fuel cell, fuel cell system comprising the stack, and method for manufacturing the stack

(76) Inventor: Dong-Hun Lee, Suwon-si (KR)

Correspondence Address: MCGUIREWOODS, LLP, 1750 TYSONS BLVD, SUITE 1800, MCLEAN, VA, 22102, US

(21) Appl. No.: 11/110,881

(22) Filed: Apr. 21, 2005

(30) Foreign Application Priority Data
Apr. 22, 2004 (KR) 10-2004-0027784

(51) Int. Cl. H01M 8/02; H01M 8/10; H01M 8/24

(52) U.S. Cl. 429/34; 429/37; 429/32

(57) ABSTRACT

A fuel cell stack includes a generator that includes a membrane electrode assembly (MEA) that has opposing side surfaces, bipolar plates that are mounted to the side surfaces of the MEA, and a bar that is mounted to the generator by forming a rivet head on at least one end of the bar.

### CROSS REFERENCE TO RELATED APPLICATION

This application claims priority to and the benefit of Korean Patent Application No. 10-2004-0027784, filed on Apr. 22, 2004, which is hereby incorporated by reference for all purposes as if fully set forth herein.

### BACKGROUND OF THE INVENTION

(a) Field of the Invention

The present invention relates to a fuel cell, and more particularly, to a stack for a fuel cell.

(b) Description of the Related Art

A fuel cell is a system that produces electricity. In a fuel cell, chemical energy from a reaction between oxygen contained in air and hydrogen contained in hydrocarbons such as methanol, ethanol, and natural gas is directly converted into electrical energy. A unique characteristic of the fuel cell is that both the electricity that is generated by the reaction between fuel and an oxidizing agent as well as its heat byproduct may be utilized.

Polymer electrolyte membrane fuel cell (PEMFC) technology has been under ongoing development. A PEMFC system's basic components include a fuel cell main body called a stack, a fuel tank, a fuel pump that supplies fuel to the stack from the fuel tank, and a reformer that converts the fuel during the process of supplying the fuel that is stored in the fuel tank to the stack to generate hydrogen gas. The reformer then supplies the hydrogen gas to the stack which allows a reaction between the hydrogen gas and oxygen to thereby generate electricity.

In the above fuel cell system, the stack is structured by consecutively stacking generators that are each comprised of a membrane electrode assembly (MEA) and bipolar plates that are provided on both sides of the MEAs. In the MEA, an anode and a cathode are provided with an electrolyte layer interposed in between them. The MEA functions to effect oxidation/reduction of the hydrogen and air. The furthermost ends of the stack are formed of bipolar plates or end plates that are separate from the generators.

In order to prevent the leakage of fuel in a PEMFC structure, the plurality of the stacked generators must be connected as a single unit. To realize such a configuration, adjacent generators are interconnected using an adhesive to form a single unit. Alternatively, when the generators are closely stacked together, inward pressure is applied to the end plates to hold the generators closely together.

FIG. 8 shows a schematic view of a conventional fuel cell stack that utilizes the above-mentioned configuration, in which inward pressure is applied to the stack to maintain its closely held structure. A plurality of generators 200 are stacked after mounting the end plates 210, 210′, which support the generators 200 at outermost ends of the stack. In addition, a plurality of connecting bars 220 are screw-coupled to the end plates 210, 210′ using nuts 230.

After the connecting bars 220 are inserted into through holes 210a, 210a′ that are formed in the end plates 210, 210′, the nuts 230 that are formed on both ends of the connecting bars 220, are engaged with screw threads. This results in a coupling force to be applied to the end plates 210, 210′ such that the generators 200 are pressed together into a single unit.

However, since screw coupling is used in the above conventional stack structure, the connection strength of the electricity generators is dependent solely on the degree of tightness of the nuts. In addition, the process of tightening all of the nuts is inconvenient and time-consuming. Further, during assembly of the conventional stack, washers are also needed for screw coupling. This extra component increases the costs that associated with the use, management of, and overall cost of production of the stack.

### SUMMARY OF THE INVENTION

The present invention provides a stack for a fuel cell. The number of parts necessary for assembly of the connecting structure of generators that comprise the stack is reduced as a result of the simplified structure of the present invention. The reduction in the number of parts lowers manufacturing costs. Further, the manufacture of the present invention is simplified by reducing the number of steps that are involved in assembling the stack. Finally, the connection strength between the generators is increased.

The present invention also provides a fuel cell system that comprises the stack.

The present invention also provides a method for manufacturing the stack.

Additional features of the invention will be set forth in the description which follows, and in part will be apparent from the description, or may be learned by practice of the invention.

The present invention discloses a fuel cell stack that comprises a generator that includes an MEA that has opposing side surfaces and bipolar plates that are mounted to the side surfaces of the MEA. The stack further comprises a bar that is mounted to the electricity generator by forming a rivet head on at least one end the bar.

The present invention also discloses a fuel cell stack that comprises a generator that includes an MEA that has opposing side surfaces and bipolar plates that are mounted to the side surfaces of the MEA. The fuel cell stack further comprises press plates that are connected to the generator and a bar that is mounted to the press plates by forming at least one end into a rivet head to secure the generator and the press plates together.

The present invention also discloses a method of manufacturing a fuel cell stack comprising forming connecting holes in a generator that forms the stack and in press plates that contact the generator. Bars are inserted into the connecting holes of the generator and the press plates where at least one end of the bars form a rivet head such that the bars are connected to the generator and the press plates through a rivet connection.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which together with the specification illustrate exemplary embodiments of the present invention, and, together with the description, serve to explain the principles of the present invention.

FIG. 1 is a schematic view of a fuel cell system according to the present invention.

FIG. 2 is a schematic view of a fuel cell stack according to a first exemplary embodiment of the present invention that illustrates elements involved in a manufacturing method of the stack.

FIG. 3 is a partial side view that illustrates a fuel cell stack according to a second exemplary embodiment of the present invention.

FIG. 4 is a side view that illustrates a fuel cell stack according to a third exemplary embodiment of the present invention.

FIG. 5 is a side view that illustrates a fuel cell stack according to a fourth exemplary embodiment of the present invention.

FIG. 6 is a partial enlarged view that illustrates a fuel cell stack according to a fifth exemplary embodiment of the present invention.

FIG. 7 is a flow chart of a method for manufacturing a fuel cell stack according to an exemplary embodiment of the present invention.

FIG. 8 is a schematic side view of a conventional fuel cell stack.

### DETAILED DESCRIPTION OF THE EMBODIMENTS

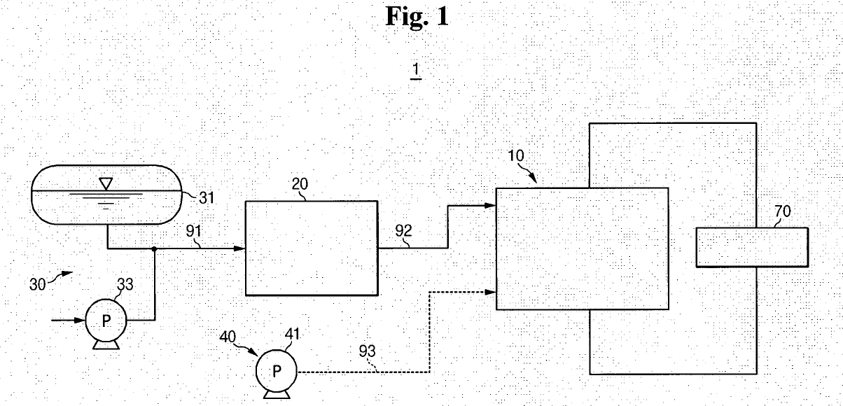

FIG. 1 is a schematic view of a fuel cell system 1 according to the present invention. As shown in FIG. 1, the system 1 includes a reformer 20 that converts liquid hydrocarbon fuel to generate hydrogen gas and a stack 10 that converts chemical energy obtained from reaction between hydrogen generated by the reformer 20 and outside air into electrical energy to thereby generate electricity. In addition, the system 1 comprises a fuel supply unit 30 that supplies the liquid fuel to the reformer 20, and an air supply unit 40 that supplies air to the stack 10 for use in the generation of electricity. The system 1 further includes a cooling unit 70 that cools the stack 10.

If a direct oxidation fuel cell configuration is used as system 1 of the present invention, the reformer 20 may be omitted from the system. The following description of the present invention utilizes PEMFC technology for the fuel cell system 1. However, the present invention is not limited to this configuration.

In addition to converting liquid fuel into hydrogen by a reforming reaction for use by the stack 10 the reformer 20 may be structured to reduce the concentration of carbon monoxide contained in the reformed gas. Thus, the reformer 20 includes a reforming device that converts liquid hydrocarbon fuel to generate hydrogen, and a carbon monoxide reducer that reduces the concentration of carbon monoxide in the reformed gas.

The reforming device converts fuel into a hydrogen-rich reformed gas through a catalytic reaction such as steam reforming, partial oxidation, or autothermal reaction. The carbon monoxide reducer reduces the concentration of carbon monoxide in the reformed gas by a catalytic reaction method such as hydrogen gas conversion or selective oxidation, or other methods such as hydrogen refining utilizing a separation layer.

The fuel supply unit 30 includes a fuel tank 31 that stores liquid fuel and a fuel pump 33 that is connected to the fuel tank 31. The fuel pump 33 discharges the liquid fuel that is stored in the fuel tank 31. The fuel supply unit 30 and the reformer 20 are coupled through a first supply line 91.

The air supply unit 40 includes an air pump 41 that supplies outside air to the stack 10. The air pump 41 is connected to the stack 10 through a third supply line 93.

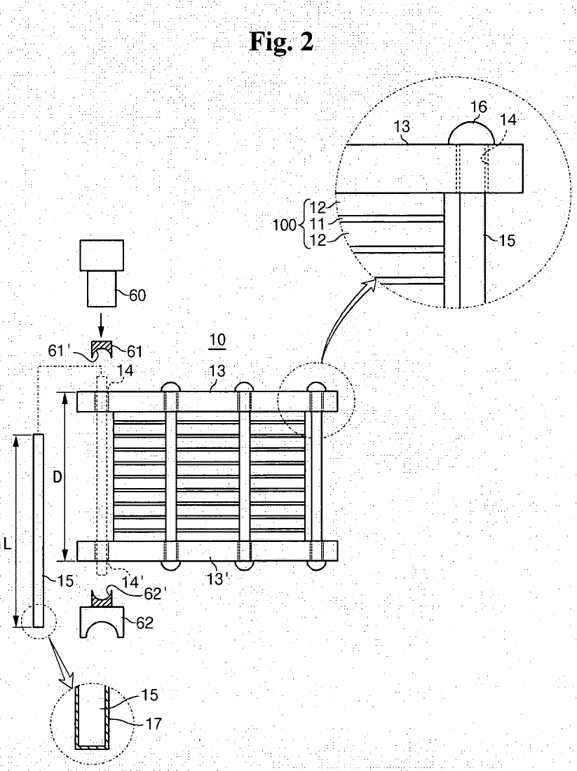

FIG. 2 is a schematic side view of a fuel cell stack according to a first exemplary embodiment of the present invention.

With reference to FIG. 2, the stack 10 of the fuel cell system 1 of the present invention includes a plurality of generators 100 that receive hydrogen from the reformer 20 and outside air from the air supply unit 40. The generators generate electric energy by inducing oxidation and reduction reactions of the hydrogen and oxygen from air.

Each of the generators 100 includes an MEA 11 for effecting oxidation and reduction reactions of hydrogen and oxygen and bipolar plates 12 that supply the hydrogen and air containing oxygen to the MEA 11. A bipolar plate 12 is positioned on each side of the MEA 11. The stack 10 is formed by stacking a plurality of the generators 100.

Press plates 13, 13′ that compress the stacked generators 100 together are mounted to press against the outermost generators 100. However, in the present invention, the press plates 13, 13′ may be omitted, and the outermost bipolar plates 12 function themselves as press plates. Another possible configuration is that the press plates 13, 13′, may press together the generators 100 as well as function as bipolar plates.

To secure the generators 100, the stack 10 further includes bars 15 that are inserted in connecting holes 14, 14′ that are formed in the press plates 13, 13′. The bars 15 use rivets to secure themselves to the press plates 13, 13′. The press plates 13, 13′ may have larger dimensions than the generators 100, requiring that the connecting holes 14, 14′ are formed at predetermined intervals along outer circumferential portions of the press plates 13, 13′.

In this exemplary embodiment as shown in FIG. 2, the connecting holes 14, 14′ and the bars 15 are formed with circular cross sections. The bars 15 have a smaller cross-sectional diameter than that of the connecting holes 14, 14′ to allow for easy insertion into the connecting holes 14, 14′. Further, a length (L) of the bars 15 prior to undergoing the rivet connection is greater than a distance (D) between the press plates 13, 13′ such that the ends of the bars 15 are protruded outwardly from the press plates 13, 13′ when inserted into the connecting holes 14, 14′. As a result, end portions of the bars 15 that protrude outwardly from the press plates 13, 13′ may be formed into rivet heads 16.

The rivet connections of the bars 15 on the press plates 13, 13′ receive a predetermined pressure by the resulting connection force when the generators 100 are stacked between the press plates 13, 13′ so that the generators 100 are secured together and form the stack 10 into an integral structure.

The rivet connecting configuration is formed using tools such as a hammer 60, a snap 61, and a holder 62. As shown by the hashed lines in FIG. 2, if the end portions of one of the bars 15 are inserted into an opposing pair of connecting holes 14, 14′ that are formed in the press plates 13, the holder 62 is closely contacted to one end of the bar 15, while the snap 61 is closely contacted to the other end of the bar 15 to thereby support the bar 15. Subsequently, the snap 61 is struck by the hammer 60 such that the ends of the bar 15 are formed to correspond to the shape of depressions 62′, 61′. The depressions 62′, 61′ are formed in the holder 62 and the snap 61, respectively, resulting in the formation of the rivet heads 16. In this embodiment, the depressions 62′, 61′ are hemispherical in shape, but are not limited thereof.

Accordingly, two press plates 13, 13′ that press against the generators 100 that are mounted in between them by a rivet connection of the bars 15 are realized by the above process.

The bars 15 may be made of a nonconducting material. Alternatively, an insulation layer 17 made of a synthetic resin, for example, may be formed on a surface of the bars 15. This configuration prevents electrical short circuits between the generators 100 or between the press plates 13, 13′ and the adjacent generators 100.

In addition, the bars 15 may be made of a material that undergoes minimal thermal deformation such as mild steel, alloyed steel, or light alloyed steel. Mild steel refers to steel that comprises approximately 0.2% carbon. Alloyed steel refers to heat-resistant steel that comprises large amounts of chromium and nickel, and may also comprise non-corrosive chromium steel and stainless steel. Light alloyed steel refers to low-weight aluminum or magnesium alloyed steel.

In addition, the bars 15 may be structured such that their end portions are made of a different material than their center portions. For example, the ends of the bars 15 that will be formed into rivet heads 16 may be made of a malleable material such as aluminum. Alternatively, the ends of the bars 15 may undergo a heat-treating process such as annealing to make them more malleable than other areas of the bars 15.

Additional embodiments of the present invention will now be described. Elements that are identical to those of the first exemplary embodiment will be indicated using like reference numerals.

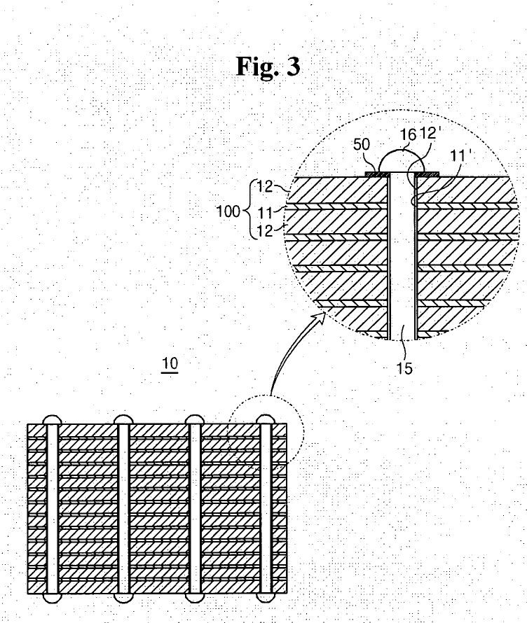

FIG. 3 is a side view of the stack 10 according to a second exemplary embodiment of the present invention.

As shown in FIG. 3, the stack 10 of this embodiment includes one or more generators 100 that each comprises an MEA 11 and a pair of the bipolar plates 12 that are mounted to side surfaces of the MEA 11.

Connecting holes 11′, 12′ are formed in the generators 100. When a plurality of generators 100 are stacked, the bars 15 are inserted into channels that are formed by aligning the connecting holes 11′, 12′ of the generators 100. The ends of the bars 15 are formed into rivet connections such that the generators 100 are secured together.

Thus, in contrast to the first embodiment, the stack 10 of the second embodiment utilizes a configuration in which the bars 15 are inserted directly into the generators 100 rather than into press plates to thereby secure a plurality of the generators 100 following the rivet connections of the bars 15.

The connecting holes 11′, 12′ are formed in areas of the generators 100 that are not involved in the generation of electricity. These may be areas that are outside the catalyst layer and dispersion layer of the MEAs 11, and parts of the bipolar plates 12 that are outside the flow channel formation regions.

The connecting holes 11′, 12′ are formed in the same shape and in the same positions with respect to all of the generators 100. Accordingly, when the generators 100 are stacked, the connecting holes 11′, 12′ are aligned to form long channels. The bars 15 are passed through the connecting holes 11′, 12′ to interconnect the generators 100. A plurality of the connecting holes 11′, 12′ may be formed at predetermined intervals in outer circumferential areas of the generators 100. Alternatively, the connecting holes 11′, 12′ may be formed only in the corners of the generators 100, or in both corners of the generators 100 and areas in between.

In addition, annular washers 50 may be interposed between the rivet heads 16 of the bars 15 and the bipolar plates 12 of the outermost generators 100. The washers 50 may be made of a flexible material such as rubber that increases the strength of the connection of the rivet heads 16 to prevent a loosening of the rivet connection due to temperature changes of the stack 10 or in the environment surrounding the stack 10. The washers 50 may be mounted onto the bars 15 prior to the formation of the rivet heads 16.

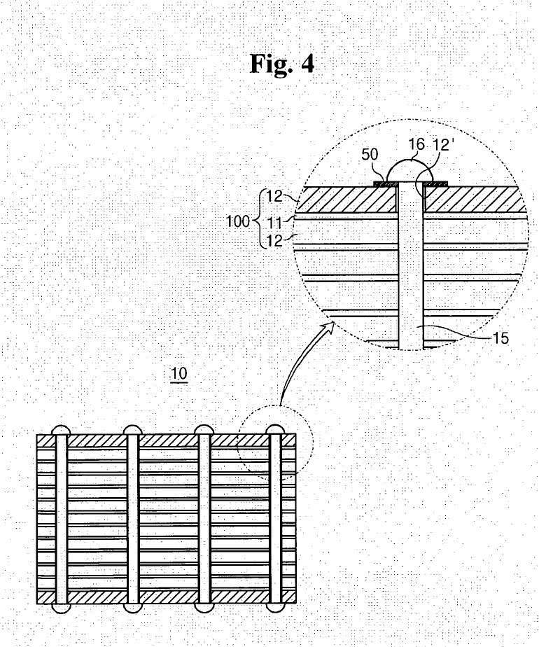

FIG. 4 shows the stack 10 according to a third exemplary embodiment of the present invention. As shown in FIG. 4, the rods 15 are not connected to all of the generators 100 as in the second embodiment, but are instead are connected to only the outermost generators 100 through rivet connections to thereby secure all the generators 100.

Other aspects of the third embodiment of the present invention are identical to those of the second embodiment, and hence, a detailed description thereof will not be provided herein.

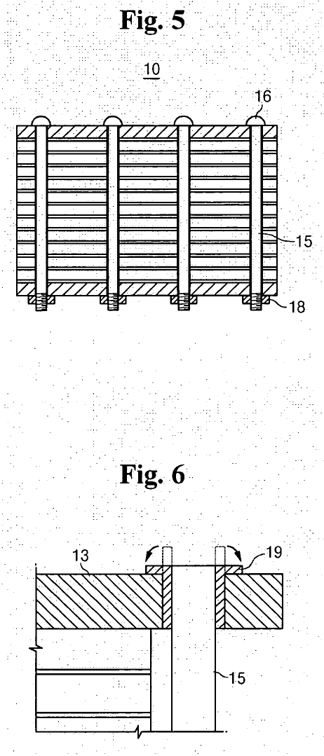

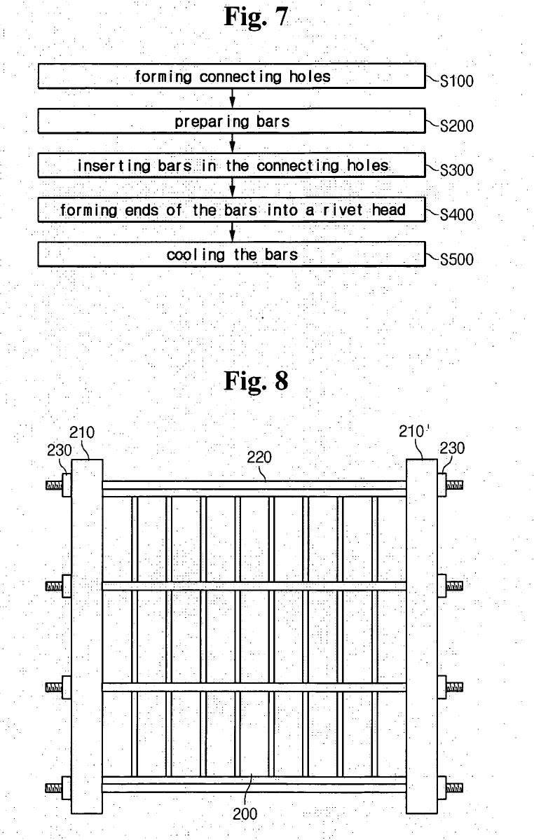

FIG. 5 shows the stack according to a fourth exemplary embodiment of the present invention. As shown in FIG. 5, the stack 10 according to this embodiment utilizes both a rivet connection and a threaded fastener to secure a plurality of the generators 100.

The stack 10 according to the fourth exemplary embodiment has the same basic structure as the stack of the third exemplary embodiment. However, in this embodiment, one end of each of the bars 15 is formed into the rivet head 16, while the other end is formed with screw threads to which a nut 18 is engaged. The structure of the fourth embodiment may be applied also to the stacks shown in FIG. 2 and FIG. 3.

FIG. 6 is a partial sectional view of the stack 10 according to a fifth exemplary embodiment of the present invention. As shown in FIG. 6, the stack 10 of this embodiment has the same basic structure as the first exemplary embodiment. However, the rivet heads 19 that form the rivet connections of the bars 15 are formed from the bars 15 and additional members.

The stack 10 of this embodiment is structured such that when the bars 15 are inserted into the connecting holes 14, the tubular rivet heads 19 are inserted into the connecting holes 14, and ends of the bars 15 are inserted into the rivet heads 19. This configuration allows a tight connection between these elements. To strengthen the connection between the bars 15 and the rivet heads 19, an adhesive may be applied between these elements.

In the fifth embodiment, when the rivet heads 19 are inserted into the connecting holes 14, the rivet heads 19 are extended outwardly from the press plate 13 as shown by the dotted lines in FIG. 6. Actual rivet heads are formed by performing a riveting process.

As shown in FIG. 6, the rivet heads 19 may be left remaining on the press plates 13, or may be formed to be present only within the connecting holes 14.

The structure of to the fifth exemplary embodiment may also be applied to the stack structures shown in FIG. 3 and FIG. 4.

Manufacture of the stack using the rivet connection of the present invention will be described with reference to the flow chart of FIG. 7.

First, in step S100, connecting holes are formed in the generators in order to form a stack. In the case of the first exemplary embodiment, connecting holes are formed in press plates.

Next, in step S200, the bars that are to be inserted into the connecting holes are prepared for assembly. This involves heating the bars to a predetermined temperature in order to thermally expand them to enable hot riveting. The heating temperature is set to between 60° C. and 200° C.

The bars 15 are then inserted into the connecting holes in step S300. In the case of the first embodiment, the bars are inserted into the connecting holes of the press plates. Washers may be mounted over the ends of the bars.

Next, the snap, holder, and hammer as described above are used to rivet the ends of the bars in step S400. Since the bars are heated to a predetermined temperature, riveting is easily performed.

In step S500, after the rivet process, the stack is cooled for a predetermined time at room temperature to cool the bars. This cooling induces a connecting pressure that results from the contraction of the bars 15 such that the rivet head portions are further tightened against the generators or press plates, thereby securely interconnecting a plurality of the generators.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A fuel cell stack, comprising:
a generator comprising a membrane electrode assembly with side surfaces and bipolar plates that are mounted to the side surfaces of the membrane electrode assembly; and
a bar that is mounted to the generator by forming a rivet head on at least one end of the bar.

2. The fuel cell stack of claim 1,
wherein the generator is stacked in plural, and
wherein the bar is mounted to outermost generators in stack through rivet connections.

3. The fuel cell stack of claim 1,
wherein a plurality of the generators are stacked, and the bars are mounted to the generators through rivet connections.

4. The fuel cell stack of claim 1, further comprising:
a washer interposed between the rivet head and the generator.

5. The fuel cell stack of claim 1,
wherein the bar is made from a material selected from a group consisting of mild steel, alloyed steel, and light alloyed steel.

6. The fuel cell stack of claim 5, wherein the bar is made from aluminum.

7. The fuel cell stack of claim 5, wherein the bar is made from carbon steel.

8. The fuel cell stack of claim 1, wherein an insulation layer is formed on a surface of the bar.

9. The fuel cell stack of claim 1, wherein rivet areas are more malleable than other areas of the bar.

10. The fuel cell stack of claim 1, wherein rivet areas are formed on the bar and on a separate element.

11. A fuel cell stack, comprising:
a generator including a membrane electrode assembly (MEA) with side surfaces, and bipolar plates that are mounted to the side surfaces of the MEA;
press plates that are connected to the generator; and
a bar that is mounted to the press plates by forming a rivet head on at least one end of the bar.

12. A method for manufacturing a fuel cell stack, comprising:
forming connecting holes in a generator that forms the stack and in press plates that contact the generator;
inserting bars in the connecting holes of the generator or the press plates; and
forming at least one end of the bars into a rivet head such that the bars are connected to the generator and the press plates through a rivet connection.

13. The method of claim 12,
wherein the bars are inserted in the connecting holes that are formed in at least the outermost of the plurality of generators that are stacked together.

14. The method of claim 12, wherein in the bars are preheated when they are inserted into the connecting holes.

15. The method of claim 14,
wherein the temperature is between 60° C. and 200° C.

16. The method of claim 12, further comprising:
cooling the stack after the bars undergo a rivet connection.
